(19) United States
(12) Patent Application Publication
(10) Pub. No.: US 2023/0364879 A1
(43) Pub. Date: Nov. 16, 2023

(54) DEVICE AND METHOD FOR PAPERBOARD STAMPING FORMING

(71) Applicant: SHANDONG UNIVERSITY, Jinan (CN)

(72) Inventors: Zhong JI, Jinan (CN); Ying GAO, Jinan (CN); Guoxin LU, Jinan (CN); Ren LIU, Jinan (CN)

(73) Assignee: SHANDONG UNIVERSITY, Jinan (CN)

(21) Appl. No.: 17/944,370

(22) Filed: Sep. 14, 2022

(30) Foreign Application Priority Data
May 16, 2022 (CN) 2022105285350

(51) Int. Cl. B31B 50/44; B31B 50/00

(52) U.S. Cl. CPC B31B 50/44; B31B 50/006

(57) ABSTRACT

Provided a device and method for paperboard stamping forming, relates to the technical field of paper material stamping forming equipment, comprising a punch-pin and a pressure-applying component, the pressure-applying component acting on a paperboard through a fluid medium; before the punch-pin carries out a stamping forming on the paperboard, the pressure-applying component pre-deforms the paperboard and a direction of the pre-deformation is opposite to a direction of the stamping forming; aiming to the current problem that the forming depth that is difficult to meet requirements resulted in the paperboard forming paper container limited by the deformation capacity of the paperboard, the forming depth of the paper container is improved by making the paperboard deform twice in opposite directions, bringing into play the deformation capacity of the full area of the paperboard, increasing the deformable amount of the paperboard, and reducing problems such as cracks and breakage in the forming process.

### CROSS-REFERENCES TO RELATED APPLICATIONS

This application claims priority benefits to Chinese Patent Application No. 202210528535.0, filed 16 May 2022, the contents of which are incorporated herein by reference.

### TECHNICAL FIELD

The present invention relates to the technical field of equipment for paper material stamping forming, and specifically to a device and method for paperboard stamping forming.

### BACKGROUND

Compared with traditional plastic containers, paper-based materials such as paper cups, paper plates, paper bowls, and other paper containers have low cost, high environmental friendliness, and good sustainability, especially in the packaging field where containers are used in large quantities. At present, most of the paper containers on the market mostly adopt two-piece bonding forming, or pulp molding forming, both of which are relatively mature. However, the two-piece bonding forming has the disadvantage of more waste and is prone to liquid leakage in the bonding area. The pulp molding forming has low productivity and high energy consumption in the drying process.

The manufacture of seamless paper containers can be realized by stamping forming. At present, the stamping forming production is mostly concentrated in single-layer paperboard, and the production efficiency is low; in addition, unlike metal materials with high ductility, paper-based materials have low plasticity and poor deformation ability and formability. Therefore, only paper tray containers with small depth can be produced by stamping forming. For paper containers with large depth, such as paper cups, paper bowls, and deep paper trays, due to their deformation properties, the paper-based materials are easy to tear during the stamping forming and to be difficult to produce seamless containers with large depth in batches. At the same time, in the stamping forming process of multi-layer paperboard, the paperboard in contact with the die is prone to crack, damage, and other defects during the forming process, which limits the deformation of the paperboard and makes it difficult not only to increase the forming depth of paper containers but also affects the forming quality and efficiency of paper containers.

### SUMMARY

In view of the defects existing in the prior art, the present invention provides a device and method for paperboard stamping forming, which can give full play to the deformation ability of the whole area of the paperboard by making the paperboard deform twice in the opposite direction, improve the variable shape of the paperboard, reduce the cracks, damages and other problems during the forming process, and improve the forming depth of the paper container.

According to a first object of the present invention, provided a device for paperboard stamping forming, comprising:
a punch-pin and a pressure-applying component, the pressure-applying component acting on the paperboard through a fluid medium; before the punch-pin carries out a stamping forming on the paperboard, the pressure-applying component pre-deforms the paperboard and the direction of the pre-deformation is opposite to a direction of the stamping forming.

Further, the pressure-applying component comprises a pressure-applying chamber with an opening towards the punch-pin, the fluid medium filling the pressure-applying chamber and forming a pre-action surface for contacting the paperboard.

Further, the pressure-applying component comprises a regulating mechanism connected to the pressure-applying chamber to vary the pressure, temperature, and/or humidity applied to the paperboard by the pressure-applying component.

Further, the pressure-applying component and the punch-pin act on the opposite sides of the paperboard.

Further, comprising a fixture and a cavity mold, the fixture is mounted on the cavity mold and is provided with a clamping portion for clamping an edge of the paperboard, and the multiple layers of the paperboard are staggered sequentially in the thickness direction.

According to a second object of the present invention, provided a method for paperboard stamping forming, comprising:
clamping an edge of the paperboard, and applying a pre-acting force to the paperboard to produce a pre-deformation of the paperboard in an opposite direction to a stamping deformation;
maintaining the pre-acting force, stamping the paperboard, and overcoming the pre-acting force to cause the paperboard to produce the stamping deformation.

Further, multiple layers of the paperboard are staggered in sequence along a thickness direction of the paperboard, and the stacked paperboards are deformed together.

Further, when the pre-acting force is applied, control the pressure, temperature, and/or humidity acting on the paperboard.

Further, the paperboard is plastically deformed through the pre-acting force, and the paperboard is subjected to a first deformation process under the action of the pre-acting force and stamping action, then adjusting the pre-acting force, and the paperboard is continuously stamped to be subjected to a second deformation process, and the paperboard is plastically deformed through the stamping pressure.

Further, adjusting the temperature of a clamping area on the edge of the paperboard, and after the stamping forming, using the pre-acting force to perform a de-molding.

Compared with the prior art, the present invention has the advantages and positive effects of:
(1) According to the present invention, aiming to the current problem that the forming depth that is difficult to meet requirements resulted in the paperboard forming paper container limited by the deformation capacity of the paperboard, the forming depth of the paper container is improved by making the paperboard deform twice in opposite directions, bringing into play the deformation capacity of the full area of the paperboard, increasing the deformable amount of the paperboard, and reducing problems such as cracks and breakage in the forming process.
(2) According to the present invention, the pressure applying component can be applied to the paperboard by the fluid medium, so that the paperboard can be deformed in the opposite direction of stamping, giving full play to the deformation capacity of the center area of the paperboard; at the same time, during the punch-pin stamping process, the paperboard can be formed by deep drawing, which further gives play to the deformation ability of the surrounding area outside the central area of the paperboard, and improves the deformation ability of the paper container during stamping forming.
(3) According to the present invention, using the fluid medium to act on the paperboard, it can steadily apply the pre-acting force, and at the same time, it can avoid the frictional effect of the rigid body touching the paperboard to restrict the flow of the paperboard in the direction of the paper surface. In the stamping forming process, the fluid medium is used to maintain a certain amount of pre-acting force in the opposite direction of the stamping deformation, when the central area is impacted, the pre-acting force drives the surrounding area of the paperboard to deform, further improving its deformation and meeting the depth requirements of forming.
(4) According to the present invention, during the downward movement of the punch-pin, the pressure-applying component provides a back pressure to make the paperboard fit tightly on the punch-pin, which can effectively prevent the paperboard from sliding during the forming process to cause rupture and further improve the deformation capacity, and also ensure the shape of the formed part more precisely by the punch-pin.
(5) According to the present invention, by staggering a machine direction and cross direction arrangement of multiple layers of the paperboards, each layer of paperboard is restrained from each other during the deformation process, so that each layer of anisotropic paperboard is approximately isotropic after stacking, which is conducive to improving the forming depth and forming quality, solving the problem that single-layer paperboard is very fragile and easy to be damaged in large deformation, and also solving the problem that single-layer paperboard is easy to penetrate when it is in direct contact with compressed air, and at the same time, it also solves the problem of back pressure when the punch-pin moves down.
(6) According to the present invention, controlling one or more of the pressure, temperature, and humidity conditions in paperboard forming by the pressure applying component, adjusting the temperature and humidity of the paperboard is beneficial to improve the plasticity of the paperboard, especially the plasticity of the lowermost layer paperboard, which is most prone to rupture so that it maintains good deformability as a whole.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention and do not constitute an improper limitation of the present invention.

FIG. 1 is a schematic diagram of applying pre-acting force to paperboard in Example 1 or 2 of the present invention.

FIG. 2 is a schematic diagram of when the pre-acting force and the punching force act on the paperboard at the same time in Example 1 or 2 of the present invention.

FIG. 3 is a schematic diagram of the paperboard stamping forming process in Example 1 or 2 of the present invention.

In figures: 1, punch-pin; 2, fixture; 3, paperboard; 4, pressure applying component; 5, cavity mold.

### DETAILED DESCRIPTION

### Example 1

According to a typical example of the present invention, as shown in FIGS. 1 to 3, provides a device for paperboard stamping forming.

The paperboard stamping forming device, as shown in FIG. 1, is used for stamping forming paper-based materials to obtain paper containers, especially for the paperboard 3. By causing the paperboard 3 to deform twice in opposite directions, the full regional deformation capacity of the paperboard 3 is brought into play, the deformable amount of the paperboard 3 is increased, cracks and breakage in the forming process are reduced, and the forming depth of paper containers is increased.

The paperboard stamping forming device mainly comprises a stamping element for providing a stamping action, and a pressure-applying component 4 for providing a pre-deformation action. Before carrying out the stamping forming to the paperboard 3, applying the pressure first to the paperboard 3 through the pressure-applying component 4 to make the paperboard 3 produce a pre-deformation, and the direction of the pre-deformation is opposite to the direction of the desired stamping forming, and then under the condition of utilizing the pressure-applying component 4 to maintain a certain effect on the paperboard 3, the press element stamps the paperboard 3 to deform the paperboard 3, so that the deformation of the paperboard 3 is increased and meets the depth requirements of the paper container after forming.

For the stamping element, maybe a punch-pin 1, or may adopt a structure of the punch-pin 1 matching with a cavity mold 5. The punch-pin 1 can be configured as an internal structure of the paper container to be formed, and under the action of the stamping element, an external of the paper container receives the pressure of a fluid medium, and an internal accepts an action of the pressure of the punch-pin 1 to achieve the forming of the paperboard 3.

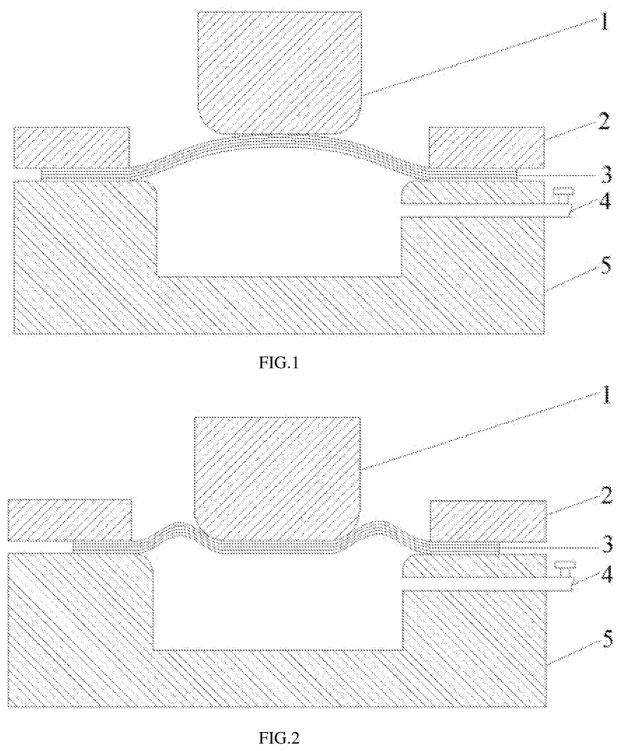

In combination with FIGS. 1 and 2, the pressure-applying component 4 comprises a pressure-applying chamber with an opening towards the punch-pin 1, and the fluid medium fills the pressure-applying chamber and forms a pre-action surface for contacting the paperboard 3.

The pressure-applying chamber of the pressure-applying component 4 can be provided by setting a container or formed by an external structure, for example, a hollow recessed area formed by the cavity mold 5 in FIG. 1 can be used as the pressure-applying chamber; the pressure-applying chamber is communicated with a fluid medium supply element, which the fluid medium can be delivered through a fluid medium pump combined with a pipe to fill into the pressure-applying chamber, one side of the paperboard 3 faces the opening of the pressure-applying chamber, the paperboard 3 receives the action of the pressure of the fluid medium filled in the pressure-applying chamber.

By changing the volume of the fluid medium in the pressure-applying chamber, an acting force can be applied to the paperboard 3; by adjusting the pressure of the fluid medium to change the pre-acting force to the paperboard 3, a pre-deformation state of the paperboard 3 can be adjusted, as shown in FIG. 1, by filling the pressure-applying chamber with fluid medium to make the paperboard 3 produce a plastic expansion in the opposite direction of the stamping.

It should be noted in particular that the fluid medium can be air, by filling the pressure-applying chamber with air as the fluid medium, the compressed air acts on the paperboard 3 to make the paperboard 3 pre-deformation; because some paper containers need to hold liquid or solid-liquid mixed state items, will use the paperboard 3 material that is not easily wetted by liquid, at this time the fluid medium can also use the liquid that does not damage the paperboard 3, such as water.

It is understood that to avoid the influence of the fluid medium when forming the paperboard 3, a film material can also be provided between the paperboard 3 and the pressure-applying chamber for isolation, and the film material can deform with the paperboard 3 without limiting the deformation of the paperboard 3. At this time, an organic fluid medium such as oil or an inorganic fluid medium such as water, which is easy to control the pressure, can be used to achieve the pre-deformation of the paperboard 3.

In the example, air as the fluid medium is introduced as an example. The pressure-applying component 4 applies the acting force to the paperboard 3 through the air to pre-deform the paperboard 3, which can steadily apply the pre-deformation force, and at the same time, it can avoid the frictional effect of the rigid body touching the paperboard 3 to restrict the flow of the paperboard 3 in the direction of the paper surface, thus ensuring the plastic deformation of the paperboard 3 and giving full play to the deformation ability of the paperboard 3 subjected to the pressure area of the fluid medium.

When using the fluid medium, one or more of the parameters of the pressure, temperature, and humidity acting on the paperboard 3 can be adjusted. The pressure-applying component 4 comprises a regulating mechanism, which can change the pressure of the fluid medium delivered, and can also change the temperature of the fluid medium delivered, and can also change the humidity of the fluid medium delivered, so that the paperboard 3 can be in a suitable state to improve its deformation capacity by changing the pressure, temperature or humidity, or changing two or three of these parameters at the same time.

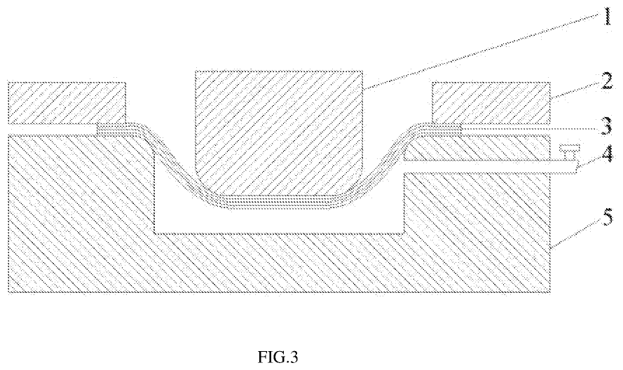

As shown in FIGS. 2 and 3, the paperboard stamping forming device further comprises a fixture 2 and the cavity mold 5; the fixture 2 is mounted on the cavity mold 5 and is provided with a clamping portion for clamping the edge of the paperboard 3.

The fixture 2 clamps an edge position of the paperboard 3 along the circumference of the paperboard 3, and a middle area of the paperboard 3 receives the action of the fluid medium and the punch-pin 1 to produce the plastic deformation; as shown in FIG. 1, the hollow concave area of the cavity mold 5 is also used as the pressure-applying chamber of the pressure-applying component 4, and by communicating a fluid medium source with a through hole on the cavity mold 5, an adjusting component can be configured on a transmission pipeline between the through hole and the fluid medium source, or the parameters of the fluid medium output by the fluid medium source can be adjusted directly.

In the example, the fixture 2 can adopt the existing fixture 2 of the existing paperboard 3 stamping processing equipment to achieve the stable clamping of single or multi-layer paperboard 3.

To avoid damage to the paperboard 3 during forming, the contact surface of the punch-pin 1 applying stamping pressure is rounded and smooth, and for some features, the prismatic position can be rounded to reduce the scratching during forming at the prismatic position. At the same time, the positions where the cavity mold 5 and the fixture 2 contact the paperboard 3 are also rounded.

The pressure-applying component 4 can act on the paperboard 3 through the fluid medium, so that the paperboard 3 can produce the plastic expansion in the opposite direction of stamping, giving full play to the deformation capacity of the center area of the paperboard 3. At the same time, during the stamping process of the punch-pin 1, the paperboard 3 is formed by deep drawing, giving play to the deformation ability of the area between the central area of paperboard 3 and the edge clamping area, and improving the deformation ability of the paper container during stamping

The fluid medium can fully deform the center region of the paperboard 3 by exerting a pre-acting force on the paperboard 3. During the stamping forming process, the fluid medium is used to maintain a certain pre-acting force opposite to the direction of stamping deformation, and the pre-acting force drives the surrounding region of the paperboard 3 to deform when the center region is subjected to stamping pressure and causes the paperboard 3 to wrap around the punch-pin 1 to enhance the stability of the paperboard 3 and further meet the demand for depth and precision of forming.

To meet the processing efficiency requirements, the fixture 2 can simultaneously clamp multiple layers of stacked paperboard 3 and simultaneously realize the stamping deformation of multiple layers of stacked paperboard 3. It is understood that since the requirements for deformation accuracy when forming paper containers from paperboard 3 are lower than those for metal processing and forming, it is possible to obtain paper containers that meet the requirements by stamping multiple layers together.

In addition, it should be noted that when the multiple layers of the paperboard 3 are stacked and co-formed, the multiple layers of the paperboard 3 are staggered in a machine direction and a cross direction staggered arrangement, so that the fibers of adjacent layers of the paperboard 3 are distributed at an angle, and each layer of the paperboard 3 is mutually restrained during the deformation process, so that each layer of anisotropic paperboard 3 is approximately isotropic after stacking, which is conducive to improving the forming depth and quality.

### Example 2

Another typical example of the present invention, as shown in FIGS. 1 to 3, provides a method of paperboard stamping forming.

The paperboard stamping forming method, comprising:
stacking multiple layers of paperboard 3 sequentially in a staggered manner along the thickness direction of the paperboard 3, with the stacked paperboard 3 deformed together;
clamping edges of the paperboards 3 and applying a pre-acting force to the paperboards 3 to produce a pre-deformation of the paperboards 3 in a direction opposite to the stamping deformation;
maintaining the pre-acting force, stamping the paperboards 3, and overcoming the pre-acting force to cause the paperboard 3 to produce the stamping deformation.

To keep the paperboards 3 in a suitable state of deformation, one or more parameters of pressure, temperature, and humidity acting on the paperboard 3 are controlled when the pre-acting force is applied.

It is also necessary to regulate the temperature in the clamping area along the edges of the paperboards 3 to ensure the performance of the paperboards 3 in the clamping position and to avoid problems such as tearing.

Specifically, the paperboard stamping forming method can utilize a paperboard stamping forming device as in Example 1, with the punch-pin 1 mounted on the slide of the press and the cavity mold 5 mounted on the workbench of the press. When the press is operating, the punch-pin 1 and the cavity mold 5 produce relative motion.

The edges of the paperboards 3 are clamped by the fixture 2, and the pressure-applying chamber is closed after the paperboards 3 are clamped so that the pressure-applying chamber can maintain a certain pressure and a gap between the clamped paperboards 3 and a bottom of the cavity mold 5 is maintained. The pressure-applying chamber is formed through a cavity of the cavity mold 5, and the pressure-applying component 4 uses air as the fluid medium to apply the acting force on the paperboards 3, and the pressure-applying component is communicated with an air supply system. The air supply system provides compressed air at a certain pressure, temperature, and humidity, and can be pressurized and depressurized at the right time according to the process requirements.

The compressed air at a certain temperature and humidity is conducive to improving the plasticity of the paperboards 3, especially the plasticity of the lowermost layer (in direct contact with the cavity mold 5) of the paperboards 3, which is most prone to rupture.

The method for paperboard stamping forming is introduced with reference to FIGS. 1 to 3, comprising the steps of:
(1) stacking multiple layers of paperboard 3, in a staggered arrangement of a machine direction (MD) and a cross direction (CD), and placing them between the punch-pin 1 and the cavity mold 5;
(2) keeping the punch-pin 1 and the cavity mold 5 at a certain distance;
(3) pressing the multiple layers of the paperboards 3 onto the cavity mold 5 with the fixture 2;
(4) introducing compressed air of a certain pressure, temperature, and humidity into the cavity of the cavity mold 5 through the air supply system;
(5) under the clamping of the fixture 2 and the cavity mold 5 and the pressure of the compressed air, the multiple layers of the paperboards 3 are jointly arched upward and plastically deformed until they touch the bottom of the punch-pin 1;
(6) the air supply system continues to provide compressed air, the punch-pin 1 moves downward, and the paperboards 3 continue to deform plastically upward until the paperboards 3 wrap the bottom of the punch-pin 1 and the rounded area of the punch-pin 1, forming a double-arch structure as shown in FIG. 2;
(7) the air supply system depressurizes, but still maintains a certain pressure while the punch-pin 1 continues to move downward;
(8) under the combined action of the punch-pin 1, the fixture 2, the cavity mold 5, and the back pressures provided by the air supply system, the multiple layers of the paperboards 3 are pressed against the punch-pin 1 and deform plastically downward together, forming multiple paper containers at the same time, as shown in FIG. 3;
(9) the punch-pin 1 and the fixture 2 move up, and the plurality of paper containers move up and out of the mold at the same time under the combined action of the punch-pin 1 and the back pressure provided by the air supply system; and
(10) removing the paper containers from the mold to complete the paper container stacking stamping forming process.

When stacking multiple layers of the paperboard 3, take the four layers of the paperboard 3 shown in FIG. 1 as an example, being stacked together in a staggered arrangement of MD and CD, i.e., the MD of the first layer of the paperboard 3 overlaps with the CD of the second layer of the paperboard 3, and so on, and are placed between the punch-pin 1 and the cavity mold 5 after stacking.

In one stroke of the punch-pin 1, the multiple layers of the paperboard 3 are formed into multiple paper containers simultaneously, greatly improving production efficiency; at the same time, adopting the upward and downward (i.e., forward and reverse) two-time forming method to bring into play the full regional deformation capacity of the paperboard 3, greatly increasing the deformable amount of the paperboard 3 and improving the depth of paper container forming.

In the example, the compressed air with a pressure of 1.5 MPa, a temperature of 80° C., and a relative humidity of 40% is passed into the cavity of the cavity mold 5 through the air supply system.

First, the compressed air makes the multiple layers of the paperboards 3 upward to produce the plastic expansion, giving full play to the deformation capacity of the central area of the paperboards 3, and then the punch-pin 1 moves downward (at this time, the crimping force can be reduced according to the process requirements) to make the paperboard 3 downward to produce the deep drawing, giving further play to the deformation capacity of the surrounding area of the paperboard 3.

It can be understood that, as in the prior art, in the one-time forming method by moving down the punch-pin 1 only, the paperboards 3 touch the bottom of the punch-pin 1 at the beginning, and the bottom of the punch-pin 1 will restrict the radial flow of the material due to friction so that the deformation capacity of the central area of the paperboards 3 will not be developed.

During the punch-pin 1 moves down, the air supply system provides the back pressure to make the paperboards 3 tightly fit on the punch-pin 1, which effectively prevents the paperboard 3 from sliding and causing rupture during the deep drawing and forming process, and improves the deformation capacity and forming quality.

Multiple layers of the paperboard 3 are staggered and stacked together to solve the problem of single-layer paperboard 3 is very fragile and easily broken during large deformation, as well as the problem of easy penetration when the single-layer paperboard 3 is in direct contact with the compressed air, and the problem of the back pressure when the punch-pin 1 moves down, and also the problem of forming difficulties caused by the anisotropy of single-layer paperboard. The compressed air supplied by the air supply system is also directly used to de-mold multiple paper containers from the cavity mold 5, further improving production efficiency and ease of operation.

The paperboard stamping forming method is simple and reliable as a whole, which simplifies the production process and shortens the production process.

The foregoing descriptions are merely preferred embodiments of the present invention but are not intended to limit the present invention. A person skilled in the art may make various alterations and variations to the present invention. Any modification, equivalent replacement, or improvement made within the spirit and principle of the present invention shall fall within the protection scope of the present invention.

What is claimed is:

1. A device for paperboard stamping forming, comprising a punch-pin and a pressure-applying component, the pressure-applying component acting on a paperboard through a fluid medium; before the punch-pin carries out a stamping forming on the paperboard, the pressure-applying component pre-deforms the paperboard and a direction of the pre-deformation is opposite to a direction of the stamping forming.

2. The device for paperboard stamping forming according to claim 1, wherein the pressure-applying component comprises a pressure-applying chamber with an opening towards the punch-pin, the fluid medium filling the pressure-applying chamber and forming a pre-action surface for contacting the paperboard.

3. The device for paperboard stamping forming according to claim 2, wherein the pressure-applying component further comprises a regulating mechanism connected to the pressure-applying chamber to vary the pressure, temperature, and/or humidity applied to the paperboard by the pressure-applying component.

4. The device for paperboard stamping forming according to claim 1, wherein the pressure-applying component and the punch-pin act on the opposite sides of the paperboard.

5. The device for paperboard stamping forming according to claim 1, wherein further comprising a fixture and a cavity mold; the fixture is mounted on the cavity mold and is provided with a clamping portion for clamping an edge of the paperboard; multiple layers of the paperboard are staggered sequentially in a thickness direction.

6. A method for paperboard stamping forming, comprising:
clamping an edge of the paperboard, and applying a pre-acting force to the paperboard to produce a pre-deformation of the paperboard in an opposite direction to a stamping deformation;
maintaining the pre-acting force, stamping the paperboard, and overcoming the pre-acting force to cause the paperboard to produce the stamping deformation.

7. The method for paperboard stamping forming according to claim 6, wherein multiple layers of the paperboard are staggered in sequence along a thickness direction of the paperboard, and the stacked paperboards are deformed together.

8. The method for paperboard stamping forming according to claim 6, wherein the pressure, temperature, and/or humidity acting on the paperboard are controlled when the pre-acting force is applied.

9. The method for paperboard stamping forming according to claim 6, wherein the paperboard is subjected to a first deformation process under the action of the pre-acting force and stamping action, then adjusting the pre-acting force, and the paperboard is continuously stamped to be subjected to a second deformation process, and the paperboard is plastically deformed through the stamping pressure.

10. The method for paperboard stamping forming according to claim 6, wherein adjusting the temperature of a clamping area on the edge of the paperboard, and after the stamping forming, using the pre-acting force to perform a de-molding.
